(19) United States
(12) Patent Application Publication
(10) Pub. No.: US 2002/0185512 A1
(43) Pub. Date: Dec. 12, 2002

(54) Hand-held tape dispenser

(76) Inventor: Kumud Shah, Nairobi (KE)

Correspondence Address: MARKS & CLERK, 350 BURNHAMTHORPE ROAD WEST, SUITE 402, MISSISSAUGA, ON, L5B 3J1, CA

(21) Appl. No.: 09/875,259

(22) Filed: Jun. 7, 2001

(51) Int. Cl. B26F 3/02

(52) U.S. Cl. 225/56; 225/66

(57) ABSTRACT

A hand-held adhesive tape dispenser is adapted to be engaged by the hand, and particularly the fingers of the hand, with a roll of tape placed over a post. A platform overlies the finger engaging clasp, and the post extends upwardly from the platform, so that the tape unreels horizontally with respect to the supporting platform. A cutter extends perpendicularly to the platform, and is protected at both ends by a pair of projecting tabs. The width of the cutter is greater than the width of the adhesive tape; and a pair of tape engaging planes extends rearwardly from the cutter. The tape dispenser may be worn on either hand, and the tape may be unreeled in either direction, depending on the preferences of the user.

### FIELD OF THE INVENTION

The present invention relates to tape dispensers, and particularly to tape dispensers which may be secured on the hand of a user so that adhesive tape may be dispensed therefrom. The hand-held adhesive tape dispenser of the present invention is configured so as to provide a guard whose purpose is to preclude inadvertent contact of the finger or other part of the body of the user, or a package or wrapping being worked on, with the cutter which is disposed at one end of the hand-held adhesive tape dispenser.

### BACKGROUND OF THE INVENTION

There are very often circumstances where it is desired to have a dispenser for ordinary household adhesive tape—as well as for packaging tape in some instances—which is intimately associated with one of the hands of the user. For example, shop attendants whose task it is to wrap packages with paper which is held in place with adhesive, find the remote placement of a typical tape dispenser on the table or desk to be quite inconvenient. Indeed, any person who is engaged in wrapping parcels with paper—typically, gift wrapping for birthdays or at holiday times—finds it quite inconvenient to have to continually reach for a tape dispenser so as to remove a length of tape therefrom.

Accordingly, as will be noted hereafter, there have been several hand-held tape dispensers, or tape dispensers which mount to the wrist or arm of a user, but which are either expensive to purchase, difficult to use, or present a risk of cutting or scratching a finger or body part of the user.

Also, many tape dispensers of the sort which are hand-held are designed so as to orient the roll of tape so that it is perpendicular to the hand. This is found to be inconvenient in many instances, because when a tape is being dispensed from a tape dispenser and a length thereof is to be cut, the cutting action requires a twisting action of the tape and moving the tape into another plane other than that in which it is dispensed tangentially from the roll of tape to the cutter. When the roll of tape is disposed vertically to the hand, the consequent cutting action to remove a length of tape from the tape dispenser is, at best, awkward.

Still further, in most prior art tape dispensers that are held by the hand or wrist, the cutter portion of the dispenser is left quite exposed. This presents serious risk to the fingers of the other hand, and it also presents risks such as when a person using a prior art dispenser inadvertently attempts to scratch an itchy nose or cheek, for example, there could be substantial damage done to the face by way of inadvertent contact of the unprotected cutter with the face.

Still further, some prior art tape dispensers contemplate the use of a strap employing hook and loop fasteners to engage the dispenser to the arm or wrist. The use of such a strap and fasteners may significantly increase the cost of production of the dispenser, and thus its price.

Dispensing tape horizontally—that is, in the plane of the back of the hand, for example—is found to be more intuitive in many respects, if the tape dispenser is secured to the wrist or hand. However, the prior art dispensers of that sort are, in fact, arranged for attachment to the wrist of the user, and it has been found that dispensing tape from such a wrist-held tape dispenser, especially the act of cutting a length of tape from the dispenser, again results in an awkward action. Of course, it is well known, for example, that eye-hand coordination is much finer when it comes to control of the extremities of the arm—that is, the fingers—than when it comes to control of the placement of the wrist. In other words, control of the fingers is a fine motor skill, control of the wrist and its placement is a course motor skill.

The present inventor has quite unexpectedly discovered that by placing a tape dispenser which is associated with the fingers of the hand, particularly between the upper and first knuckles of the fingers, and with the tape dispenser being arranged so as to dispense tape horizontally with respect to the plane of the back of the hand, there is no significant interference with the dexterity of the finger tips of the hand on which the tape dispenser is worn, and yet dispensing of tape so as to cut a length of adhesive tape from a roll thereof is much more intuitive and easily accommodated.

Typically, of course, a hand-held tape dispenser in keeping with the present invention is worn on the fingers of the left hand by right-handed persons, and on the fingers of the right hand by left-handed persons. Moreover, each user may decide whether to place a roll of adhesive tape on his or her hand-held dispenser in such a manner as to unreel the tape clockwise or counterclockwise, depending on preference.

Typically, as will be noted hereafter, a right-handed person will normally place a roll of adhesive tape on the hand-held adhesive tape dispenser so that the tape is unreeled clockwise, and so that the cutting action comprises a motion which is generally towards the body and downwardly from the hand. It follows, therefore, that a typical left-handed person would place a roll of tape on a hand-held adhesive tape dispenser in keeping with the present invention so that the tape is unreeled in a counterclockwise fashion.

No matter what choice is made, and no matter on which hand the hand-held adhesive tape dispenser of the present invention is to be worn, its configuration is such that it will accommodate that choice.

### DESCRIPTION OF THE PRIOR ART

Oakes U.S. Pat. No. 3,993,230, issued Nov. 23, 1976, teaches an adhesive tape dispenser which may be fitted to the fingers of one hand of the user. However, the dispenser is such that the roll of tape is oriented in a plane which is vertical to the back of the hand. Moreover, the cutter for the tape is exposed, and of the same width as the tape, making dispensing somewhat more difficult and creating risk to the user.

Walker et al U.S. Pat. No. 4,928,864, issued May 29, 1990, discloses another hand-held tape dispenser which fits over the back of the hand. This dispenser is said to overcome a disadvantage of the Oakes dispenser, which might inhibit the dexterity of the use of the fingers of the hand on which the tape dispenser is placed. However, the Walker et al tape dispenser also orients the roll of tape vertical to the plane of the back of the hand, and presents an exposed cutter which is no wider than the width of the tape to be dispensed. This arrangement makes the dispensing of tape quite awkward.

Waddell U.S. Pat. No. 5,215,236, issued Jun. 1, 1993, teaches avariation of the Walker et al tape dispenser. However, in this case, the clip-on clasp that fits over the back of the hand is adapted to receive an ordinary disposable tape dispenser of the sort which is found otherwise in the market. The same disadvantages apply; the width of the cutter is no greater that the width of the tape to be dispensed, and the cutter is exposed. As well, of course, the roll of tape is oriented vertically to the plane of the back of the hand.

Hambleton U.S. Pat. No. 5,961,066, issued Oct. 5, 1999, teaches a tape dispenser which is adapted to be fitted to the wrist of the user's arm. A yoke portion engages the wrist, and another hook and loop pair of straps is passed around the wrist. A roll of adhesive tape such as packing tape is placed over a rod which is centrally disposed on the top portion of the dispenser, so that the roll of packing tape lies in the same plane as the top portion of the dispenser which overlies the wrist. This patent is quite silent as to the manner in which the tape is, in fact, dispensed and cut from the roll.

Hicks et al U.S. Pat. No. 6,085,955, issued Jul. 11, 2000, also teaches a wrist mounted tape dispenser which is adapted to support a roll of adhesive tape over the wrist for unreeling and cutting the tape therefrom. The dispenser is attached to the wrist by a strap which employs hook and loop fasteners. The cutter is quite exposed, presenting considerable risk to the user. Moreover, dispensing and cutting a length of tape away from the roll of tape mounted on the tape dispenser is awkward and not intuitive. Once again, the width of the cutter is essentially the same as the width of the tape to be dispensed.

### SUMMARY OF THE INVENTION

The present invention provides a hand-held adhesive tape dispenser for dispensing adhesive tape from a roll thereof, where the adhesive tape is wound onto a hub having a known inside diameter. The tape dispenser comprises a hand engaging means, a platform, a tape hub receiving post, a cutter, a pair of tape engaging planes, and a pair of upper and lower projecting tabs.

The hand engaging means is adapted to engage the hand or wrist of the user.

The platform is above the hand engaging means, so that the hand engaging means subtends from the platform.

The tape hub receiving post is upstanding from the platform in a central region thereof. The post has a crosswise dimension which is less than the known inside diameter of a hub for a roll of adhesive tape, and further includes a stop means at the end of the post remote from the platform so as to preclude inadvertent removal of a roll of adhesive tape when placed over the post.

The cutter is oriented in a plane which is perpendicular to the platform on a longitudinal axis thereof which bisects the platform and the finger engaging clasp.

A pair of tape engaging planes extends at an angle from the cutter towards the platform, in respective planes which are perpendicular to the plane of the platform.

A pair of upper and lower projecting tabs is placed above and below the cutter, respectively, so as to project outwardly from the cutter along the longitudinal axis, and so as to project outwardly from the cutter at both sides of the tab perpendicularly away from the longitudinal axis.

The height of the cutter is greater than the width of any adhesive tape on a roll thereof which is placed over the post.

The upper projecting tab is above the plane of the platform at a distance therefrom greater than the width of any adhesive tape on a roll thereof which is placed over the post; and the lower projecting tab is below the plane of the platform.

Typically, each of the upper and lower projecting tabs is in a plane which is directed downwardly or upwardly, respectively, towards the plane of the platform.

Typically, the cutter is serrated, so as to include a plurality of cutting teeth which project forwardly along the longitudinal axis.

In particular embodiments of the present invention, the hand engaging means is a finger engaging clasp which is adapted for fitment to at least two fingers of the hand of a user.

Also, in specific embodiments of the present invention, the tape hub receiving post is a two-part circular post which has a diameter that is less than the known inside diameter of a hub for a roll of adhesive tape.

The two-part post is generally configured so as to comprise two semi-circular sections, each having at least a semi-circular wall which is upstanding from the platform.

The stop means comprises a downwardly and outwardly directed retaining tab at the top of each of the semi-circular walls.

Each of the two semi-circular sections of the two-part post may further include a diametrically disposed wall which is upstanding from the platform and which extends between the ends of the respective semi-circular walls.

If so, typically each of the diametrically disposed walls extends perpendicularly to the longitudinal axis.

The dispenser of the present invention may further comprise two pairs of perpendicularly disposed ridges which are upstanding from the platform. A first pair of ridges extends along the longitudinal axis at each side of the post; and the second pair of ridges extends perpendicular to the longitudinal axis, with at least one of the second pair of ridges being on a line which is beyond the centre of the post at the side thereof remote from the cutter.

In any embodiment of the present invention, the finger engaging clasp has a centre line which is perpendicular to the longitudinal axis, and is symmetric about the centre line. The finger engaging clasp may be adapted to engage two fingers of a user's hand.

The centre line of the post is disposed on the longitudinal axis behind the centre line of the finger clasp, so as to be at the side thereof which is remote from the cutter.

In one embodiment of the finger engaging clasp, it comprises two outer and oppositely curved arms depending downwardly from beneath the platform, which are adapted to engage the fingers of a user's hand with the fingers disposed between the two outer curved arms.

In another embodiment of the finger engaging clasp, there are two inner and oppositely curved arms depending in back-to-back fashion downwardly from beneath the platform. Those arms are adapted to engage the fingers of a user's hand with the fingers disposed outwardly of the two inner curved arms.

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this invention will now be described by way of example in association with the accompanying drawings in which:

FIG. 1 is a perspective view of a first embodiment of hand-held adhesive tape dispenser in keeping with the present invention;

FIG. 2 is another perspective view of the embodiment of FIG. 1, showing a roll of tape disposed on the tape dispenser;

FIG. 3 is a further perspective view of the embodiment of FIG. 1, from the other side of the tape dispenser as shown in FIG. 2;

FIG. 4 is a side elevation of the embodiment of FIG. 1, taken from the same direction as the view shown in FIG. 2;

FIG. 5 is a side elevation of a further embodiment of hand-held adhesive tape dispenser in keeping with the present invention, without a roll of tape being shown disposed thereon, and with a different finger engaging clasp than that of the embodiment of FIGS. 1 to 4;

FIG. 6 is a perspective view of the embodiment of FIG. 5, with a roll of adhesive tape being disposed on the hand-held adhesive tape dispenser; and

FIG. 7 is a top view of either embodiment of hand-held adhesive tape dispenser, with a roll of adhesive tape being disposed on the dispenser.

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following discussion.

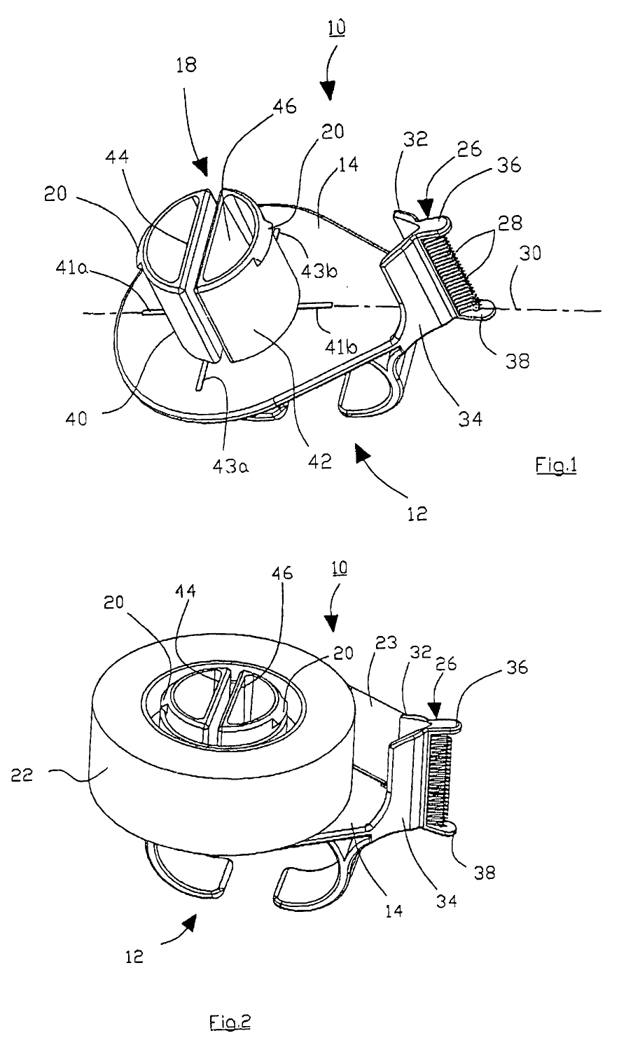

Two embodiments of hand-held adhesive tape dispenser in keeping with the present invention are particularly shown at 10 and 50, respectively, in each of FIGS. 1 and 5. The embodiments 10 and 50 differ only in respect of the configuration of their finger engaging clasps.

However, while the present discussion is particularly directed to finger-held tape dispensers, it will be appreciated that fundamentally the present invention,—which particularly requires that the roll of tape is supported from its side with the hub on which the tape is wound being placed over a post and supported or a platform from which the post extends upwardly; and

where a specifically configured cutter arrangement is provided which is symmetric on its vertical axis so that tape can be unreeled in clockwise or in counterclockwise fashion, with a pair of outwardly projecting tabs above and below the cutter edge—is applicable to any hand-held tape dispenser, whether it is in fact secured by the fingers, or grasped by the fingers, the back of the hand, or the wrist.

Thus, although specific embodiments are discussed hereafter, it will be understood that other back-of-the-hand, or wrist, engaged tape dispensers ore equally adaptable th the principals of the present invention as described herein.

Each of the embodiments 10 and 50, as well as other embodiments that may be engaged by the back of the hand, or the wrist, comprises a significant number of common elements. Thus the same reference numerals are used to denote the same elements as they are shown in the figures of drawings, and as they are discussed hereafter.

Indeed, the finger engaging clasps 12 and 52 of the embodiments 10 and 50, respectively, will be discussed first, while noting that each of the embodiments 10 and 50 comprises as one of its principal elements a platform 14.

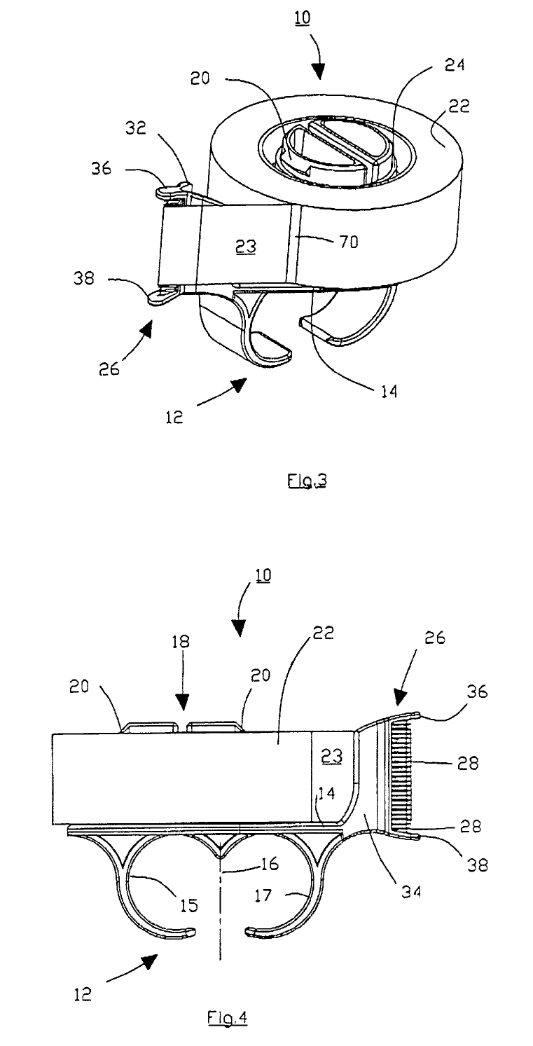

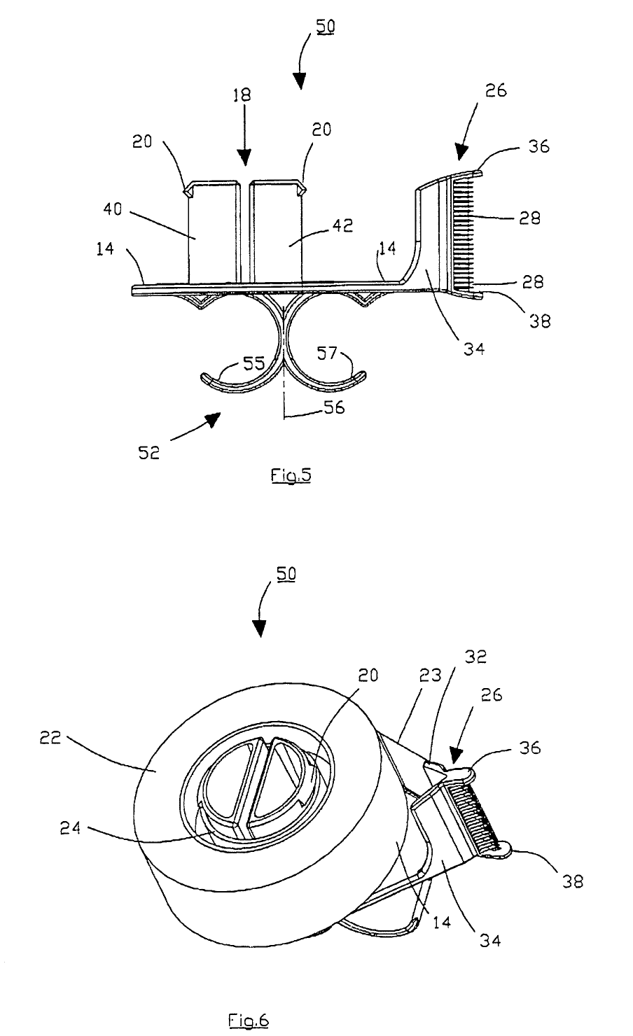

Referring to FIG. 4, the finger engaging clasp 12 is seen to have a centre line 16. The finger engaging clasp 52 of FIG. 5 is seen to have a centre line 56. Each of the finger engaging clasps 12 and 52 is symmetrical about its respective centre line 16 and 56. Also, it will be seen that typically the finger engaging clasp 12 is adapted to engage two fingers of a user's hand, and clearly the finger engaging clasp 52 is adapted to engage two fingers of a user's hand.

The finger engaging clasp 12 is best seen in FIG. 4, where it will be noted that it comprises two outer and oppositely curved arms 15 and 17, which depend downwardly from beneath the platform 14. Obviously, two fingers can be inserted in the space between the arms 15 and 17 so that the arms engage the fingers which are disposed between them.

With reference to FIG. 5, the finger engaging clasp 52 comprises two inner and oppositely curved arms 55 and 57, disposed in back-to-back fashion about the centre line 56, and depending downwardly from the platform 14. Clearly, the inner and oppositely curved arms 55 and 57 are adapted to engage the fingers of a user's hand with the fingers disposed outwardly of the two inner pair of arms 55 and 57.

Accordingly, it will be noted that in either embodiment of the hand-held adhesive tape dispenser of the present invention, the respective finger engaging clasp 12 or 52 subtends from the platform 14.

A two-part circular post 18 is seen to be upstanding from the platform 14 in a central region thereof. Clearly, in order accommodate a roll of adhesive tape, where the adhesive tape is wound onto a hub which has a known inside diameter, the diameter of the post 18 must be less than the known inside diameter of the hub for a roll of adhesive tape. Since those dimensions are standardized in the industry, no further discussion is required herein.

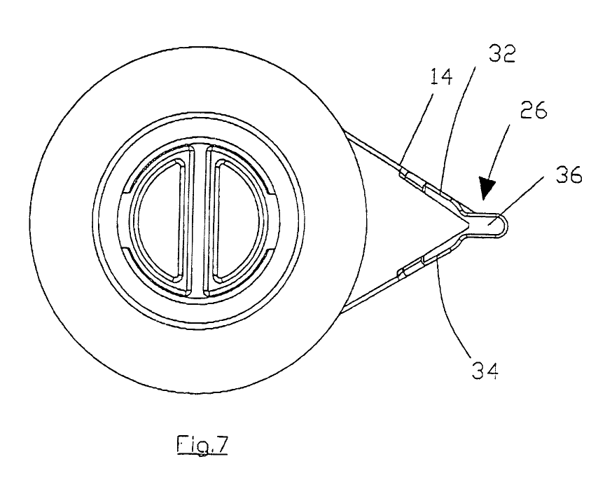

The post 18 includes stop means 20 at the top end of the post 18, which is remote from the platform 14. The purpose of the stop means 20 is to preclude inadvertent removal of a roll of adhesive tape when placed over the post. This is evident from an inspection of FIGS. 2, 3, 4, and 6, for example, where a roll of tape 22 which is wound on a hub 24 is placed over the post 18.

However, while a specific structure for the post 18 is described herein, it will be understood that any tape hub receiving post which will receive and accommodate the known diameter of the hub for a role of adhesive tape, and which has a shop means associated with the post so as to preclude inadvertent removal of a roll of adhesive tape therefrom, may be used. Thus, other configurations such as an “X”, back-to-back “C's” or “D's”, or a split circle, may be suitable as well, each having a crosswise dimension which is less than the known inside diameter of a hub for a roll of adhesive tape.

A cutter 26 is shown, and it is disposed in a plane which is perpendicular to the platform 14. The cutter 26 is typically a serrated cutter, and includes a plurality of cutting teeth 28. There is a longitudinal axis 30 for the platform 14, and that longitudinal axis 30 bisects the platform 14 and the respective finger engaging clasp 12 or 52. The cutter 26 extends along the axis 30, as of course do the teeth 28.

There is a pair of tape engaging planes 32, 34, which extend at an angle from the cutter assembly 26 towards the platform 14, each in a respective plane which is perpendicular to the plane of the platform 14. Their purpose is described in greater detail hereafter.

Also, the cutter assembly 26 comprises a pair of upper and lower projecting tabs 36, 38, respectively. The tabs 36 and 38 are placed above and below the cutter 26, and each of the tabs 36 and 38 projects outwardly from the cutter 26 and the teeth 28 thereof along the longitudinal axis 30 and also outwardly at both sides of the longitudinal axis 30, perpendicularly therefrom.

The purpose of the pair of upper and lower projecting tabs 36, 38, is to provide a guard for the cutter 26, and particularly the teeth 28 thereof, and so as to preclude inadvertent contact of a finger, or other body parts such as the face, ear, or nose, of the user, as discussed above.

It will be seen particularly in FIGS. 4 and 5, and it will also be noted from FIGS. 2, 3, and 6, that the height of the cutter 26 between the upper and lower projecting tabs 36, 38, is greater than the width of any adhesive tape on a roll 22 which may be placed over the post 18. Therefore, precise alignment of the adhesive tape 23 with the cutter 26, and particularly with the teeth 28 thereof, is not absolutely required.

Typically, the height of the cutter 26 between the projecting tabs 36, 38, is 15% to 40% greater than the width of a standard roll of adhesive tape.

It will be seen particularly in FIGS. 4 and 5 that the upper projecting tab 36 is above the plane of the platform 14 at a distance therefrom which is greater than the width of any adhesive tape 23 on a roll 22 thereof which is placed over the post 18.

It will also be seen in FIGS. 4 and 5 that the lower projecting tab 38 is below the plane of the platform 14.

Typically, again as seen particularly in FIGS. 4 and 5, each of the upper and lower projecting tabs 36,38, is in a plane which is directed downwardly or upwardly respectively, towards the plane of the platform 14.

The post 18 is a two-part post, and typically comprises two semi-circular sections each of which has at least a semi-circular wall 40 or 42, as seen particularly in FIGS. 1 and 5. Each of the semi-circular walls 40 and 42 is upstanding from the platform 14.

Also, as noted, the stop means 20 typically comprises a pair of downwardly and outwardly directed retaining tabs which are disposed at the tops of each of the semi-circular walls 40 and 42, as seen in any of the figures of drawings.

Usually, the two semi-circular sections of the two-part post 18 further include diametrically disposed walls 44, 46 which are also upstanding from the platform 14, and which extend between the ends of the respectively semi-circular walls 40, 42. It is usual for the diametrically disposed walls 44, 46 to extend perpendicularly across the longitudinal axis 30, as seen in FIG. 1 for example.

Also shown in FIG. 1 are ridges 41a, 41b, and 43a, 43b, each of which is upstanding from the platform 14. The first pair of ridges 41a, 41b extends along the longitudinal axis 30, at each side of the post 18. At least one of the second pair of ridges 43a, 43b extends perpendicular to the longitudinal axis 30, typically on a line which is beyond the centre of the post 18 at the side thereof remote from the cutter 26. Indeed, typically the ridges 43a, 43b are arranged so that one ridge 43a or 43b extends outwardly in a direction perpendicular to the axis 30 from either of the semi-circular walls 40 or 42, and the other ridge 43a or 43b extends also in a direction which is perpendicular to the longitudinal axis 30 but from the other of the semi-circular walls 40, 42.

The tape engaging planes 32, 34 serve the purpose that, if the tape 23 is unreeled from the tape 22 as shown in FIGS. 2, 3, 4, 6, and 7, the tape typically unreels from a point 70 which is below an imaginary tangent line drawn from the cutter 26 to the roll of tape 22 at the side thereof where the tape is unreeled. After a length of tape has been cut away from the roll of tape, by engagement with the teeth 28 of the cutter 26, and especially in the circumstance which is the intuitive motion whereby the tape is advanced towards the cutter 26 after the desired length has been unreeled so as to engage the cutter 26 and its teeth 28, then the portion of the tape 23 which lies immediately behind the cutter 26 will engage the respective tape engaging plane 32 or 34 so as to remain in place for the next time when it is desired to remove a length of tape from the roll 22 thereof. Accordingly, the size of the tape engaging plane 32, 34 is sufficient to provide engagement of the tacky undersurface of the adhesive tape 23. Obviously, the next action to remove a length of adhesive tape 23 away from the roll 22 is to engage that portion of the adhesive tape 23 with the thumb and finger of the other hand than that on which the hand-held tape dispenser of the present invention is engaged, and to lift the end of the tape at that point away from the respective tape engaging plane 32 or 34.

The material of the hand-held adhesive tape dispenser of the present invention is typically a suitable plastics material such as polypropylene. Typically, the entire hand-held tape dispenser 10 or 50 is injection molded, so as to require no post-injection manufacturing steps.

Also, because a suitable material such as polypropylene may be employed, there is a certain flexibility to the material of the post 18 and the stop tabs 20, which are molded sufficiently thin so as to provide that flexibility. Accordingly, a roll of adhesive tape 22 may be placed over the post 18 simply by passing the hub 24 over the downwardly and outwardly directed retaining tabs 20, which will flex or which will cause the entire post structure to flex inwardly so that the walls 44 and 46 approach each other as the hub 24 passes the retaining tabs 20.

Moreover, removal of the hub 24 from a spent roll of adhesive tape 22, or replacement of a roll with another roll of, say, another colour or opacity, is easily accomplished by squeezing the two halves of the two-part post 18 towards one another. This can be accomplished by pressing against the respective retaining tabs 20, or even more easily by pressing against the opposed diametrically disposed walls 44 and 46 in the space between those walls and the respective semi-circular walls 40 and 42.

The benefits of the present invention are clear. A more intuitive action to unreel and remove tape from a roll of adhesive tape is assured by having the roll of adhesive tape disposed horizontally with respect to the plane of the back of the hand when the hand is in an extended position, as opposed to vertically to the back of the hand or to the fingers. Also, risk of cutting or scratching the fingers of the other hand, or other body parts such as the face, or even the risk of snagging a part of the parcel being worked on or the paper or ribbon being placed on the parcel, is greatly reduced by the presence of the projecting tabs 36 and 38.

By making the height of the cutter 26 greater than the width of the tape, an easier cutting action with less concern as to the precise placement of the width of the tape across a cutter of the same width, is assured.

Other modifications and embodiments to the present invention may be considered, without departing from the spirit and scope of the present claims.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps.

What is claimed is:

1. A hand-held adhesive tape dispenser for dispensing adhesive tape from a roll thereof, where the adhesive tape is wound onto a hub having a known inside diameter, said tape dispenser comprising;
hand engaging means adapted to engage said adhesive tape dispenser to the hand or wrist of a user;
a platform above said hand engaging means, and from which said hand engaging means subtends;
a tape hub receiving post upstanding from said platform in a central region thereof, said post having a crosswise dimension which is less than the known inside diameter of a hub for a roll of adhesive tape, and said post further including a stop means at the end thereof remote from said platform to preclude inadvertent removal of a roll of adhesive tape when placed over said post;
a cutter in a plane perpendicular to said platform, and on a longitudinal axis thereof which bisects said platform and said finger engaging clasp;
a pair of tape engaging planes extending at an angle from said cutter towards said platform, in respective planes which are perpendicular to the plane of said platform; and
a pair of upper and lower projecting tabs placed above and below said cutter, respectively, so as to project outwardly therefrom along said longitudinal axis, and so as to project outwardly therefrom at both sides of said tab perpendicularly away from said longitudinal axis;
wherein the height of said cutter is greater than the width of any adhesive tape on a roll thereof which is placed over said post;
wherein said upper projecting tab is above the plane of said platform at a distance therefrom greater than the width of any adhesive tape on a roll thereof which is placed over said post; and
wherein said lower projecting tab is below the plane of said platform.

2. The dispenser of claim 1, wherein each of said upper and lower projecting tabs is in a plane which is directed downwardly or upwardly, respectively, towards the plane of said platform.

3. The dispenser of claim 1, wherein said cutter is serrated, so as to include a plurality of cutting teeth projecting forwardly along said longitudinal axis.

4. The dispenser of claim 1, wherein said hand engaging means is a finger engaging clasp adapted for fitment to at least two fingers of the hand of a user.

5. The dispenser of claim 1, wherein said tape tub receiving post is a two-part circular post having a diameter which is less that the known inside diameter of a hub for a roll of adhesive tape.

6. The dispenser of claim 5, wherein said two-part post comprises two semi-circular sections, each having at least a semi-circular wall which is upstanding from said platform; and
wherein said stop means comprises a downwardly and outwardly directed retaining tab at the top of each of said semi-circular walls.

7. The dispenser of claim 6, wherein each of said two semi-circular sections of said two-part post further includes a diametrically disposed wall upstanding from said platform and extending between the ends of the respective semi-circular walls.

8. The dispenser of claim 7, wherein each of said diametrically disposed walls extends perpendicularly to said longitudinally axis.

9. The dispenser of claim 1, further comprising two pairs of perpendicularly disposed ridges upstanding from said platform;
wherein a first pair of ridges extends along said longitudinal axis at each side of said post; and
wherein second pair of ridges extends perpendicular to said longitudinal axis, and at least one of said pair of ridges extends on a line which is beyond the centre of said post at the side thereof remote from said cutter.

10. The dispenser of claim 4, wherein said finger engaging clasp has a centre line perpendicular to said longitudinal axis, and is symmetric about said centre line; and
wherein said finger engaging clasp is adapted to engage two fingers of a user's hand.

11. The dispenser of claim 10, wherein the centre of said post is disposed on said longitudinal axis behind said centre line of said finger clasp, so as to be at the side thereof remote from said cutter.

12. The dispenser of claim 4, wherein said finger engaging clasp comprises two outer and oppositely curved arms depending downwardly from beneath said platform, and adapted to engage the fingers of a user's hand with the fingers disposed between said two outer curved arms.

13. The dispenser of claim 4, wherein said finger engaging clasp comprises two inner and oppositely curved arms depending in back-to-back fashion downwardly from beneath said platform, and adapted to engage the fingers of a user's hand with the fingers disposed outwardly of said two inner curved arms.
